(19) United States
(12) Patent Application Publication
(10) Pub. No.: US 2015/0343631 A1
(43) Pub. Date: Dec. 3, 2015

(54) Industrial Delta Type Robot

(71) Applicant: AUTOMATISCHE TECHNIK MEXICO SA. DE. C.V., Alvaro Obregon, Distrito Federal (MX)

(72) Inventor: Juan Pablo MARTINEZ-ESPONDA, Alvaro Obregon (MX)

(73) Assignee: Automatische Technik Mexico SA. DE. C.V., Alvaro Obregon, Distrito Federal, OT (MX)

(21) Appl. No.: 14/440,595

(22) PCT Filed: Feb. 14, 2014
(86) PCT No.: PCT/IB2014/000153

§ 371 Date: May 5, 2015

(30) Foreign Application Priority Data
Feb. 14, 2013 (MX) MX/A/2013/001804

(51) Int. Cl. B25J 9/06; B25J 15/02; B25J 15/06; B25J 11/00; B25J 15/00

(52) U.S. Cl. CPC B25J 9/06; B25J 11/005; B25J 15/0028; B25J 15/0023; B25J 15/0616; B25J 15/0052; B25J 15/02; Y10S 901/21

(57) ABSTRACT

A delta type robot is described. The robot comprises a base (1) where six servomotors (20) are assembled; each corresponds to three pairs (2) of articulate arms (40), each independently coupled to a torque compensation device (4) and comprised of (a) a proximal arm (41), attached on one end to a joint (44), and (b) a distal arm (45) attached on one end to a joint (44) and attached on the opposite end by means of a joint (51) to a universal effector (3) capable of coupling, manipulating and operating a wide range of tools.

### BACKGROUND

1. Field of the Invention

This description refers to an industrial robot. In particular, it refers to an industrial delta type robot, more particularly to an industrial delta type robot with three pairs of multidirectional articulate arms in the totality of the linear and rotational degrees of freedom.

2. General Background of the Invention

Industrial robots have become more popular for individuals and companies; they are especially demanded for the manipulation of objects with small dimensions that require movements of high precision and speed, in particular for product packaging operations, especially of products which have small dimensions and are fragile.

This demand from the market has been efficiently supplied by the development of robotic arms, well known in prior art.

Delta type robots have applications in diverse industries, for example in the food industry and the pharmaceutical industry. The robots are placed over conveyors or transporting belts which transport merchandise and perform diverse product collection and transport operations, to boxes or containers. Delta type robots include a base where three motors are placed equidistantly.

The motors are joined to gearboxes placed at one end of an arm, with the aim of providing movement to the arms. Each of them is attached to an effector on its opposite arm end. The effector moves in the three dimensional space formed by the X, Y, and Z axes in virtue of the aforementioned arms. Some useful references to compare the prior art with the present invention include the following patents: The European patent application No. EP 1 129 829 describes a robot for the manipulation of products in a three dimensional space. The robot comprises a base on which three arms are pivotably supported to pivot around three pivot axes arranged in a common axes planes. The three axes form a triangle with three corners. Each arm is mounted on a shaft of a servomotor connected to a controller. Three connecting linkages connect the free ends of the arms to a carrier which is movable in space in all three linear dimensions and prevented from rotation around all three rotative dimensions. A telescopic fourth linkage connects a gripper rotatably supported on the carrier by two joints with a fourth servo motor fixed to the base. In the axes plane the base has an opening through which the fourth linkage extends. The upper joint of the fourth linkage is on an opposite side of the axes plane from the carrier. By this measure the range that can be covered by the gripper can be substantially increased for a given arm length. In the latter referred patent application, unlike the proposed invention, a fourth telescopic linkage is included which increases the number of pieces and makes the assembly of the robot more difficult, which, in consequence, also increases its maintenance cost.

Moreover, the international patent application WO 00/032363 refers to a device for the firm attachment of bearing means in a three axle ball and socket joint arranged in a robot. The bearing means is arranged in housing on the joint socket and the housing includes surface against which the bearing means abuts. The surface is designed with friction increasing means that grip the bearing means and hold it.

The international patent application WO-03/106114 describes a delta robot that comprises motor/gearing units, with an assigned arm each, which are mounted on one side of a triangle. Each motor/gearing unit comprises a gearing whose, at least one, gearing step is tensioned in a rotationally symmetrical manner. The gearing is backlash free over the entire range of motion of the gearing due to a connection of gearing components with material fit or with form fit.

Moreover, the U.S. Pat. No. 4,976,582 describes a device comprised by a base element and a movable element. Three control arms are rigidly mounted at their first extremity on three shafts which may be rotated. The three assemblies, each formed by a shaft and an arm, are the movable parts of three actuators, of which the fixed parts are integral to the base element. The other extremity of each control arm is made integral with the movable element through two linking bars hingedly mounted on the one hand to the second extremity of the control arm and, on the other hand, to the movable element. The inclination and the orientation in space of the movable element remain unchanged, whatever the motions of the three control arms may be. The movable element supports a working element of which the rotation is controlled by a fixed motor situated on the base element. A telescopic arm connects the motor to the working element. The reference patent integrates a first arm section of a single element which joins to a second arm section with double element; this limits the rotational degrees of freedom and makes it totally different from the proposed invention which integrates a different arm disposition and distal arms without limits in the rotational degrees of freedom.

The U.S. Pat. No. 5,333,514 concentrates on the development of a parallel robot comprised of a base, three sets of arm assemblies disposed on the base at a predetermined spacing, and a bracket member which is supported by the arm assemblies and to which an end effector is attached. Each of the arm assemblies comprises a pair of motors mounted on the base to face each other with a predetermined clearance and a pair of arms which are supported by the motors to be swung, respectively. Each of the arms comprises a first arm portion and a second arm portion. The first arm portion and the second arm portion of each arm are connected with each other through a first joint means, and the second arm portion of each arm is connected with the bracket through a second joint means. To each set of arm assemblies movement is provided through a motor disposed in the base of the robot in a very different disposition from the one contained in the present invention in addition to the limited directions for object manipulation it presents, situation that is overcome with the present invention.

The patent U.S. Pat. No. 6,577,093 describes a delta robot for an environment with hygienic requirements, characterized in that the drive means are enclosed in an enclosure which encloses a gaseous coolant which, by a forced flow, takes up heat from the motors of the drive means.

The patent U.S. Pat. No. 6,766,711 describes a delta type robot that includes a telescopic fourth arm attached to the effector. This telescopic arm is intended for rotation of a tool placed on the effector through a motor placed on the base of the delta robot.

The United States patent U.S. Pat. No. 7,188,544 describes an industrial delta robot with an arm system rotatable in space and including a base section, a moveable plate, several multi joined pull rods and a telescopic axle arranged between the base section and the moveable plate, opposite ends of the pull rods and of the telescopic axle being connected with the base section and the moveable plate respectively, and the telescopic axle comprising an inner axle and an outer tube arranged on the inner axle and displaceable in a longitudinal direction where a pair of end to end torsional rigid bushings are arranged in a stationary manner on the outer tube in which the inner axle is mounted to be displaceable, the bushings being spaced apart at confronting inner ends to form a transversely extending lubrication pocket for continuous lubrication of the inner axle during movement relative to the bushings. From this it follows that this patent request includes a telescopic axle comprised of an inner axle and an exterior tube arranged on the outer axle and displaceable on a longitudinal direction, so that the system requires constant lubrication, which raises its maintenance costs, situation that does not occur with the proposed invention.

The delta arms of the prior art have several deficiencies, the first one of them consists in the fact that they are too rigid, in virtue that they only have three degrees of freedom on the effector, which consists of a part at the end of the arms that always moves holding a horizontal position; This makes it incapable of efficiently absorbing reaction knocks produced by the change in the direction of the movement of the arms. Another inconvenience of the delta type robots of the prior art refers to their weight. The robots are placed high and run over rails, which affects their speed because the motion over rails is slow and limited. On the other hand, the speed of movement of the robots is also limited by their own weight. A lighter robot operating without said rails results in a faster robot that can also better absorb the reaction movements generated by a change in direction.

Unlike devices in the prior art, the present invention incorporates a mechanism with six degrees of freedom (three linear and three rotational), which allows a superior effector mobility when compared to devices in the prior art.

Likewise, in the prior art torque compensation mechanisms are not incorporated. These greatly increase the agility and speed of the effector.

Another inconvenience of robots in the prior art is the lack of versatility of their effectors. Robots in the prior art must be practically designed so they can be coupled with a tool for a specific application; it is desirable to provide a single robot that can be coupled to a wide range of tools.

### SUMMARY OF THE INVENTION

A first objective of the present invention consists in providing an industrial delta type robot with six degrees of freedom.

A second objective of the invention consists in providing an industrial delta type robot at a low cost because of its easy manufacture, reduced number of parts and great versatility.

A third objective of the present invention consists in providing an industrial delta type robot which is integral, compact, resistant, easy to assemble and disassemble, and with a minimum maintenance cost.

A fourth objective of the present invention consists in providing an industrial delta type robot which is versatile and has a universal effector to which diverse interchangeable devices with diverse functions can be attached.

A fifth objective of the present invention consists in efficiently employing an industrial delta type robot in existing high volume, small dimension object manipulation systems with a great precision. A sixth objective of the invention consists in providing movement to an effector that can assume specific positions in the sixth dimensional space.

A seventh objective of the invention consists in providing a torque compensation device in the articulate arms to counteract or eliminate the forces that cause the movement and descent of the arms, universal effector, and interchangeable tools to positions lying out of the allowed limit.

An eight objective of the invention consists in providing a delta robot of simple assembly with respect to any structure.

The aforementioned objectives are achieved by providing an industrial delta type robot distinguished for comprising: (a) A robot base with three bodies, a central base section, with greater dimensions, where an attachment system is coupled in its upper side, and two secondary base sections, which comprise the upper and lower protective covers; these three bodies have a gap on each side that allows the placement of each pair of articulate double arms; (b) besides, the base of the robot has, on its central inferior side, a torque compensating device, which aims to counteract the effect of gravity over the robot's arms, the universal effector and the interchangeable tools; (c) An articulate system comprised of three pairs of multidirectional articulate arms, where each arm consists of a shoulder rotor which is connected to the servomotor through a shoulder rotor shaft, a pair of parallel arms (proximal arms), with an intermediate separator, and an elbow connector containing an arm spherical joint, that assembles a top coupling (of distal arm) that joins to a distal arm that ends on its opposite side with a bottom coupling (of distal arm) which contains an effector spherical joint; (d) A ring shaped universal effector which contains, on its exterior section, six spherical effector joints that connect with the distal arms' bottom couplings and, on its interior section, integrates perforations for the coupling of interchangeable devices; and (e) a set of interchangeable devices with electric, mechanic, pneumatic or hydraulic drive that can be coupled to the universal effector, which can consist, for example, of scissor type grippers, double grippers, servomotors or double suction cups.

### BRIEF DESCRIPTION OF THE DRAWINGS

By way of example, reference is made to the accompanying drawings.

FIG. 1 illustrates an isometric view of the industrial delta type robot of the present invention.

FIG. 2 illustrates a bottom view of the industrial delta type robot where the internal components are shown.

FIG. 3 illustrates a top view of the industrial delta type robot of the present invention.

FIG. 4 illustrates a bottom view of the industrial delta type delta robot with protective covers.

FIG. 5 illustrates a lateral view of the industrial delta type robot of the present invention.

FIG. 6 illustrates a detail of the arm torque compensation mechanical device of the robot of the present invention.

FIG. 7 illustrates an isometric view of an industrial delta type robot arm of the present invention.

FIG. 8 illustrates an exploded isometric view of the attachment of the universal effector of the industrial delta type robot of the invention.

FIG. 9 illustrates a view of two mechanically coupled arms by the union of proximal arms of the industrial delta type robot of the present invention.

FIG. 10 illustrates the attachment of the base of the delta robot of the present invention to an external structural profile.

FIG. 11 illustrates an isometric view of the industrial delta type robot effector with a scissor type gripper interchangeable device.

FIG. 12 illustrates an isometric view of the industrial delta type robot effector with a double pneumatic gripper interchangeable device.

FIG. 13 illustrates an isometric view of the industrial delta type robot effector with a servomotor interchangeable device.

FIG. 14 illustrates an isometric view of the industrial delta type robot effector with a double suction cup interchangeable device.

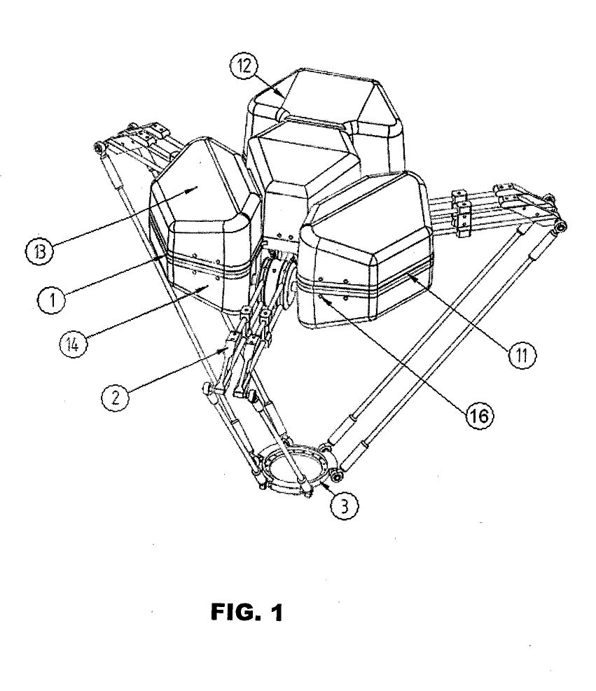

### DETAILED DESCRIPTION OF THE INVENTION

As an alternative to the existing industrial robots in the market for high volume, small object, high precision object manipulation, aimed, for example, at product packaging, the present invention provides an industrial delta type robot that exhibits an improved functionality with respect to delta robots of the prior art.

The description is made in accordance to the accompanying figures.

### Double Multidirectional Arm Articulate System

Under the present invention the industrial delta type robot uses an articulate system of three pairs (2) of multidirectional arms (40) that receive rotational motion from a respective servomotor (20), which, in turn, is firmly attached to a base (1). Each articulate arm (40) comprises (a) a proximal arm (41), attached at one end to the servomotor (20) and at the other end to a joint (44), and (b) a distal arm (45) attached at one end to the joint (44) and at the opposite end to a universal effector (3) through a joint (51).

Each proximal articulate arm (41) has one rotational degree of freedom in the rotational joint controlled by the servomotor. The rotational joint of each pair of proximal articulate arms (41) is located at the exit of the servomotor in a tangential way over an imaginary circle located at the base (1) of the robot, the axis of rotation of each of the three pairs of proximal articulate arms (41) is out of phase by 120 degrees with respect to the next rotational joint.

Each distal arm (45) is attached to the proximal arm (41) by means of a spherical joint that provides three rotational degrees of freedom to the distal arm (45) on its axes (axes X-X′, Y-Y′, and Z-Z′), located in the spherical joint between the proximal arm and the distal arm.

Each distal arm (45) is attached to the ring (50) of the effector through a second spherical joint that provides the ring (50) of the effector three rotational degrees of freedom on the axes (axes X-X′, Y-Y′, and Z-Z′), located in the spherical joint between the distal arm (45) and the effector ring (50).

As in the base (1), the axis of the spherical joint located between the distal arm (45) and the ring (50) of the effector is located tangentially over an imaginary circle located over the ring (50) of the effector of the robot, each of the three axes of the spherical joints of the distal articulate arms (45) is out of phase by 120 degrees with respect to the next spherical joint.

Even though each set of proximal (41) and distal (45) articulate arms in an open chain counts with a great number of degrees of freedom when separated from the ring (50) of the effector, when each of the three pairs of proximal (41) and distal (45) articulate arms are attached to the effector, the proximal (41) and distal (45) arms generate a closed chain that limits the degrees of freedom of the whole robot mechanism.

When the robot has its proximal (41) and distal (45) arms completely assembled to the ring (50) of the effector, the ring (50) of the effector counts with the maximum number of possible degrees of freedom in a part, a total of six degrees of freedom; three linear on the X-X′, Y-Y′, and Z-Z′ axes and three rotational on the X-X′, Y-Y′, and Z-Z′ axes.

As a result, the six proximal articulate arms (41) control the six degrees of freedom of the ring (50) of the effector, allowing the robot to have a complete control over the motion of the effector in all its degrees of freedom.

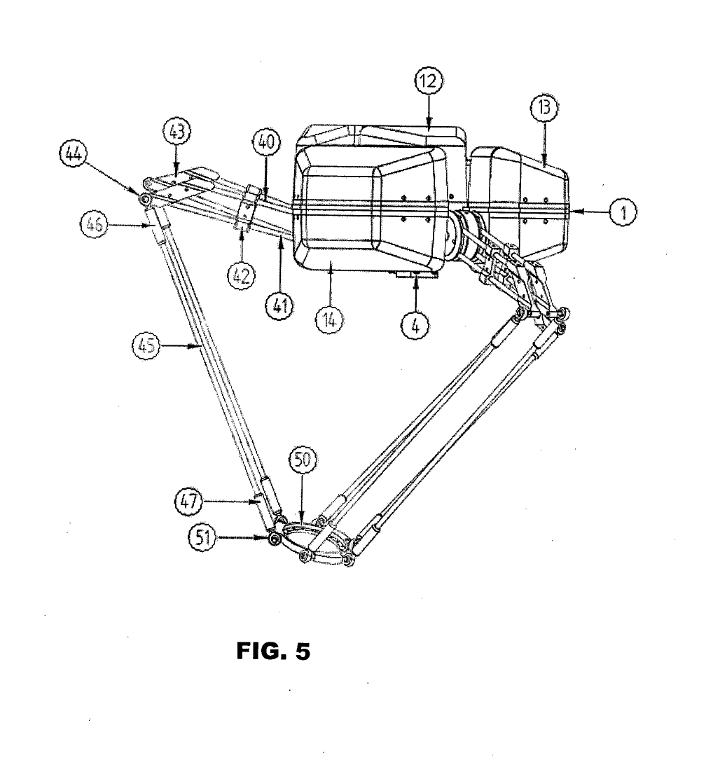

In FIG. 5 a position of the robot of the present invention is shown where the effector is not holding a vertical position. This is possible by virtue of the arms' ability to assume a determined position each. In the delta robots of the prior art the arm pairs work as if they were a single arm, by virtue of each arms' motion with a single motor. In this way, the position of the effector (3) is determined by the position of three pairs of arms and not six individual arms. The use of six independent arms means the effector can present rotational motion and maintain vertical positions in a major area compared to robots in the prior art.

The robot also has a secondary operation mode similar to the prior art. This operation mode is of great use in the industry, because the ring (50) of the effector always remains parallel to the base (1) of the robot. This mode consists in operating each pair of proximal articulate arms in the same position always, so that one of the two proximal articulate arms is leader, and the other slave (The slave is in charge of always following the leader).

In this operation mode the effector's degrees of freedom are reduced to three linear degrees of freedom in the X-X′, Y-Y′ and Z-Z′ axes, the rotational degrees of freedom in the X-X′, Y-Y′ and Z-Z′ axes of the ring (50) of the effector are disabled. To be able to use this operation mode, it is necessary to configure the first servomotor of each pair of proximal arms (41) as a leader and configure the second adjacent servomotor of each pair of proximal arms (41) as a slave. In this mode the robot shows a good performance when moving from one position to another, however, an arm joint (48) can be added, which must be firmly assembled in the top (41A) and bottom (41B) proximal arm bars of each pair of proximal arms (41).

This arm joint (48) generates a physical link between each pair of proximal arms (41) that eliminates the angular offset that might exist between each pair of proximal arms (41) and also increases the performance regarding the precision and firmness of the ring (50) of the effector when moving from one position to another, when the robot stays in a fixed position or simply when the robot is off.

### Base

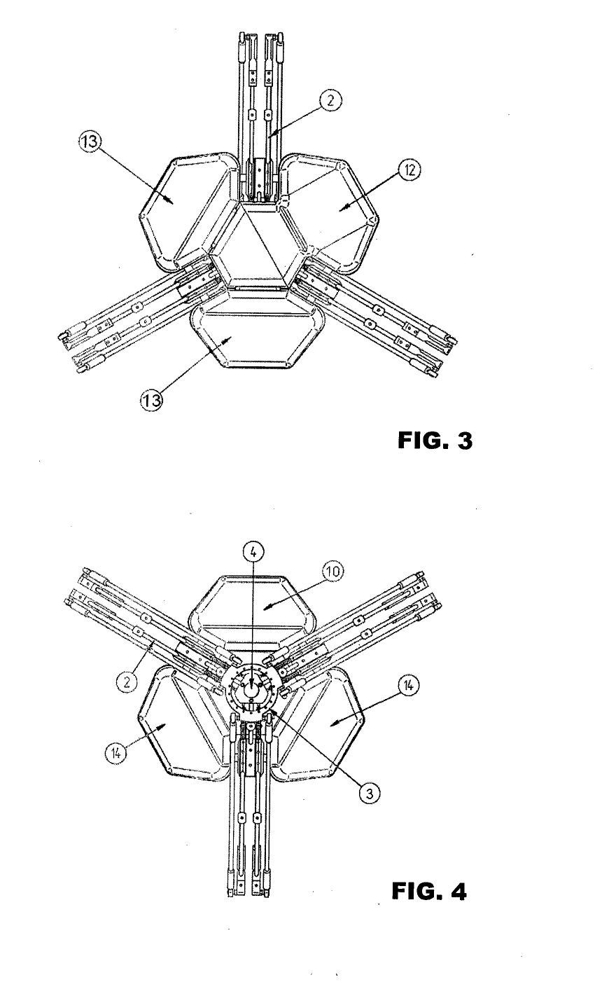

According to the present invention the industrial delta type robot uses a base (1), that consists of a horizontal plate where the following are defined: a central section (10) that includes a fixing system for an external structure so that it is possible to easily assemble the delta robot of the present invention to any structural profile, and two secondary sections (11), separated between them by a gap and an additional gap that separates each secondary section (11) from the primary, or central, section (10) for the placement of the servomotors(20) and a torque compensation device (4), refer, for example, to the FIGS. 3 and 4 which respectively illustrate a top and bottom view of the robot of the present invention. The sets of double articulate arms (2) protrude from the gap of the bodies of the base (1), each set of pair of arms (40) moves radially out of the robot over the gap defined by the aforementioned canal.

### Servomotors

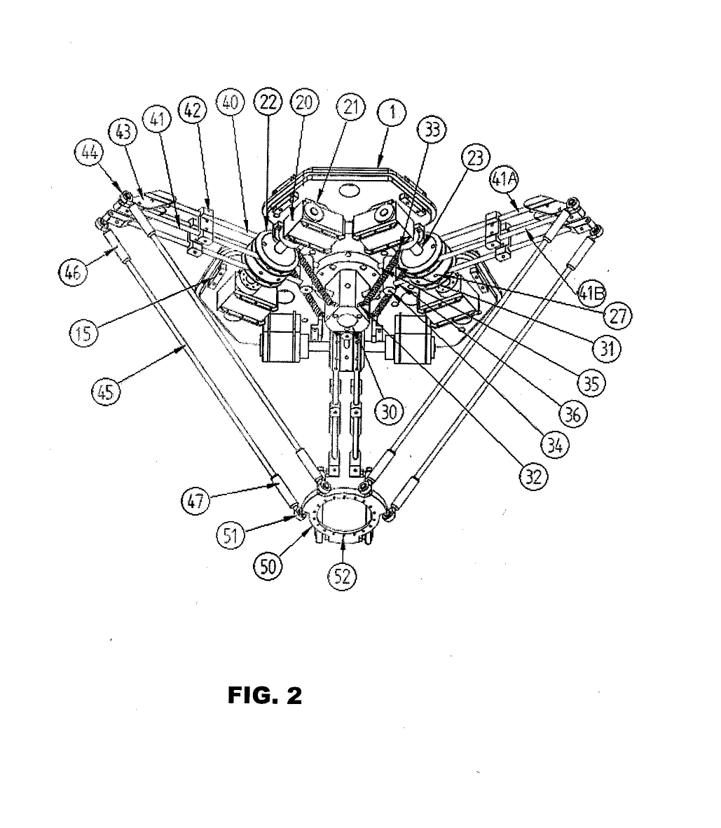

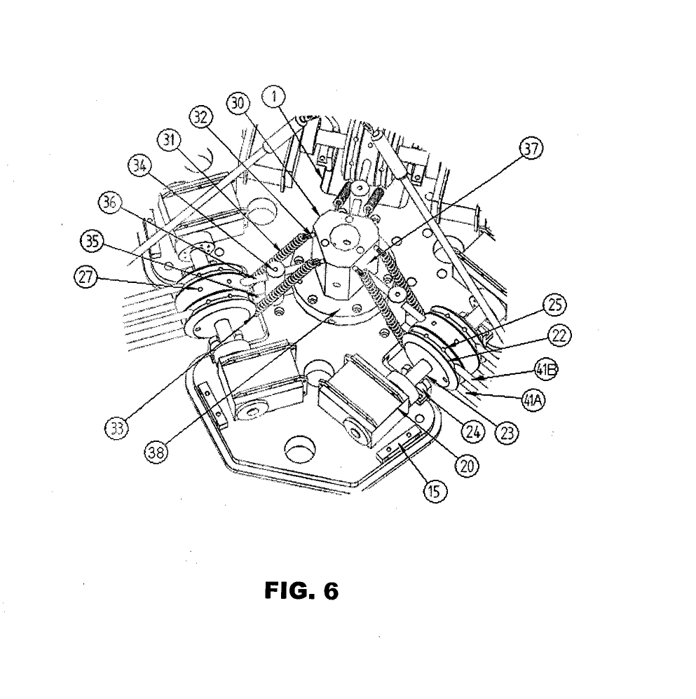

As shown in the figures (particularly FIG. 6), the servomotor (20) has a rotating shaft around which a pulley is attached, here in after referred to as shoulder rotor pulley (22), the proximal arm (41) is attached to the pulley, so that the arm extends outwards from the servomotor shaft (20) in the radial direction. As a result, the motor produces an angular motion between 90° to 70°, preferably 80°, from the center towards the upper portion and −90° to −70°, preferably −80°, from the center towards the lower portion. This angular motion results in an ascending and descending motion of the proximal arm (41) that is transmitted to the distal arm (45) and, in turn, to the effector (3). As illustrated in FIG. 2, the mechanical drive consisting of the servomotors (20), shoulder rotor pulley (22), support (27) and torque compensation device (4) are preferably placed on the lower face of the base. However, as it will be apparent to a person skilled in the art, the mechanical drive can be placed on the upper face of the base. In FIG. 6 the detail of the mechanical drive of the industrial delta type robot of the present invention is illustrated.

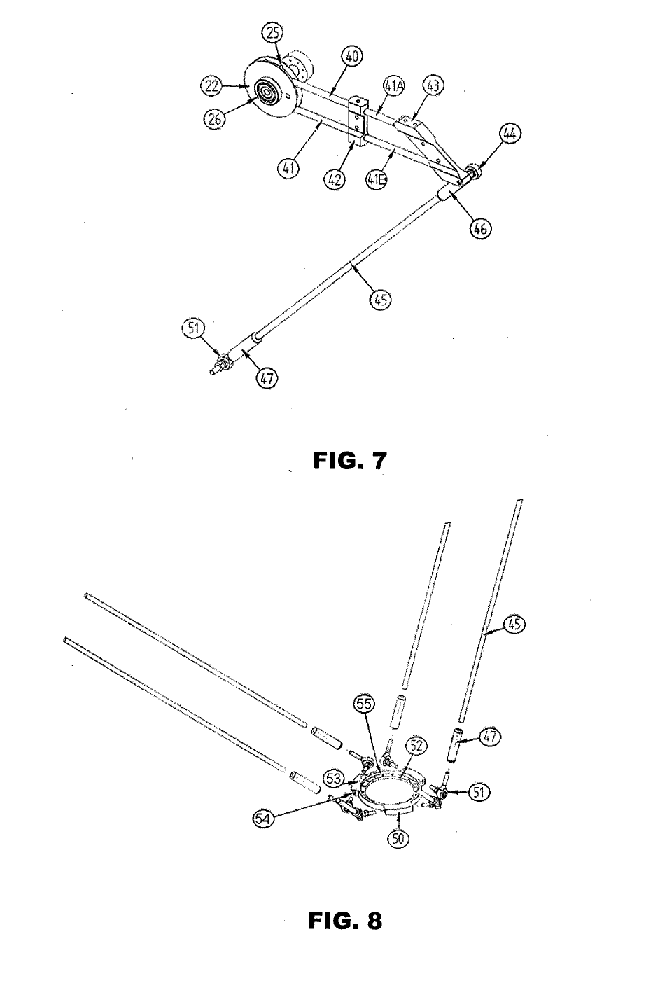

In the embodiment illustrated in FIG. 6, each of the six servomotors (20) is firmly attached to the base. Two servomotors, corresponding to the servomotors of an arm pair, each of the two secondary sections (11) facing each other with their axes aligned concentrically, so that the shoulder rotor pulleys (22) face each other and their respective servomotors lay separated over the same axis. From each servomotor (20) a shaft or axis (23) protrudes, which couples to a respective shoulder rotor pulley (22); the shoulder rotor pulley (22) is movably connected to a first face on a support (27). The support (27) includes a bearing (26) (refer to FIG. 7) so that the servomotor shaft can rotate, while the support (27) is fixed. In this way the shoulder rotor pulley can rotate but cannot move on any other direction. The support (27) has a second flat face, opposite to the first one, that includes another bearing for coupling to a second shoulder rotor that couples a respective servomotor. In this way the mechanical drive, servomotor/shoulder rotor/support/shoulder rotor/servomotor, provides the necessary torque so a pair of arms can move.

The support (27) includes a cylindrical face which has on each side flat faces, first and second; the cylindrical face is attached to a stabilizing support (34), which, in turn, is attached to a central support (30). The stabilizing support prevents the support (27) from having any type of displacement. The stabilizing support (34) is represented in FIG. 6 including two stabilizing bars, top (35) and bottom (36), attached to a vertical cylinder shaped bar. However, as will be apparent to one technically skilled in the field, the support can consist of a sill segment or an “L” angle or “C” or “I” type joist.

The central support (30) consists of a prismatic body that has, at least, three outward oriented flat faces (37). The support (30) is placed on the center of the base plate and firmly attached to it. In FIG. 6 the support (30) is shown including a flange (38) for attachment with screws (not illustrated) to base (1) on the central section of the base (10). Each of the flat faces (37) of the central support (30) is placed in front of a respective support ring (27), the base (1) provides an adequate surface for the attachment of the stabilizing support (34), allowing, for example, that one or both stabilizing bars, (35) and/or (36), can be inserted and attached to the central support (30) through the stabilizing support (34) by bolting, welding, attachment by pressure, snap or any other suitable form. The flat faces (37) also provide a surface for the placement of spring (31) anchors (32) for springs (31). The springs (31) are attached on one end to the central support and on the other to a point on the shoulder rotor pulley (22) through respective spring anchors on the side of the support (32) and the side of the shoulder rotor (33). The servomotors are designed so the arms can move while supporting their own weight and, eventually, the weight of the objects to be managed, manipulated or worked on. While working or resting, the springs (31) prevent the pulley from rotating to a determined angle, preventing the arm from descending beyond an allowed limit.

The spring (31) also eliminates vibration and reduces the torque parallel to the direction of rotation of the servomotors generated by the weight of the proximal arm assembly, the distal arm assembly, the universal effector and the current device attached to the effector.

The shoulder rotor pulley (22) includes nine perforations (25): two perforations to contain the proximal arms (41), two top perforations and two bottom perforations that serve to firmly fix the two bars of the proximal arms through set screws. The shoulder rotor pulley also has two more perforations on the back section to hold the spring anchors (33) and, finally, a lateral perforation to calibrate the distance between the shoulder rotor pulley, the arm separator and the elbow connector.

### Controller

The robot of the present invention can be controlled through a microcontroller based controller or an industrial computer based controller. The primary function of the controller is to maintain at all times control over the position, speed and acceleration of the servomotors through optimal route planning in order to perform routines designed by the operator.

The controller can carry out diverse tasks at the same time, reason for which even when it is moving the arms it is always waiting for instructions by the operator either through a user interface or the mechanical buttons placed on the structure. The controller also has an input and output, digital and/or analog interface that lets it interact with a wide range of sensors and actuators. This input and output ports are very useful, letting the controller interact with presence, distance, color, temperature, speed, weight, and pressure sensors, mechanical buttons, etc. and actuators such as motors, servomotors, pneumatic and hydraulic pistons, conveyors, diverters, valves, etc.

The controller can communicate in any protocol with devices via Bluetooth, Ethernet, Universal Serial Bus (USB), serial, etc.

The controller has libraries that allow the user to easily program new industrial processes, store information in the controller, and use it whenever it is needed. One of the libraries that have been developed for the present invention allows the user to liberate the torque of the servomotors so that he can manually place the effector in the desired positions in order to easily generate new functional routines.

Machine vision systems can also be integrated to the controller, by which, it is possible to detect the position of materials, objects, pieces, or products while they move over any type of bands, rollers or conveyors so that the robot can contact, hold, and transport them to a different desired position in an industrial process.

### Arms

In FIG. 7 an isometric view of the industrial delta type robot arm (40) is illustrated. Each set of articulate arms (2) includes two arms (40). Each articulate arm (40) comprises (a) a proximal arm (41), attached on one end to the servomotor (20) and (b) a distal arm (45). The distal (45) and proximal (41) arms are attached through a spherical joint (44). In the preferred embodiment of the invention, the proximal arms (41) comprise a top proximal arm bar (41A) and a bottom proximal arm bar (41B), both firmly attached, tangentially, on their first end to the shoulder rotor pulley (22). The top and bottom bars (41 A) and (41 B) include a separator (42) to attach them together in a parallel arrangement, said separator (42) is placed at approximately half the length of the proximal arm bars (41 A) and (41 B), and an elbow connector (43) on the second end of the bars. The elbow connector also incorporates the spherical component of a spherical joint (44).

Meanwhile, the distal arm (45) consists of a bar with a first and a second end, each coupled with a respective coupling (46) and (47) that incorporate the ring component to form a spherical joint (44) with the proximal arm (41) and the effector (3).

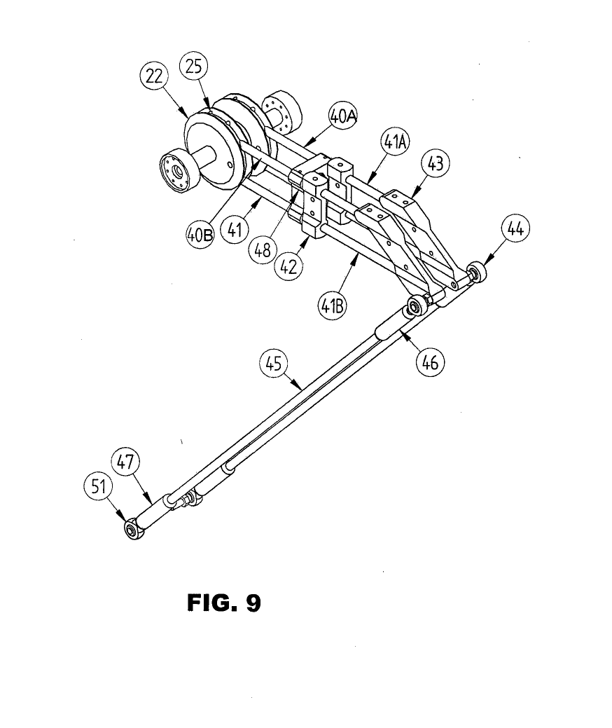

In FIG. 9 an isometric view of two adjacent arms (40) of the industrial delta type robot is illustrated. As in the previous FIG. 7, each set of articulate arms (2) pair is described and includes two arms (40), a first arm (40A) and a second arm (40B). Also, the proximal arm (48) joint is included, placed adjacently to the separator (42) so to attach them together in a parallel manner, said separator (42) and proximal arm joint (48) placed at approximately half the length of the proximal arm bars (41A) and (41B), and an elbow connector (43) at the second end of the bars.

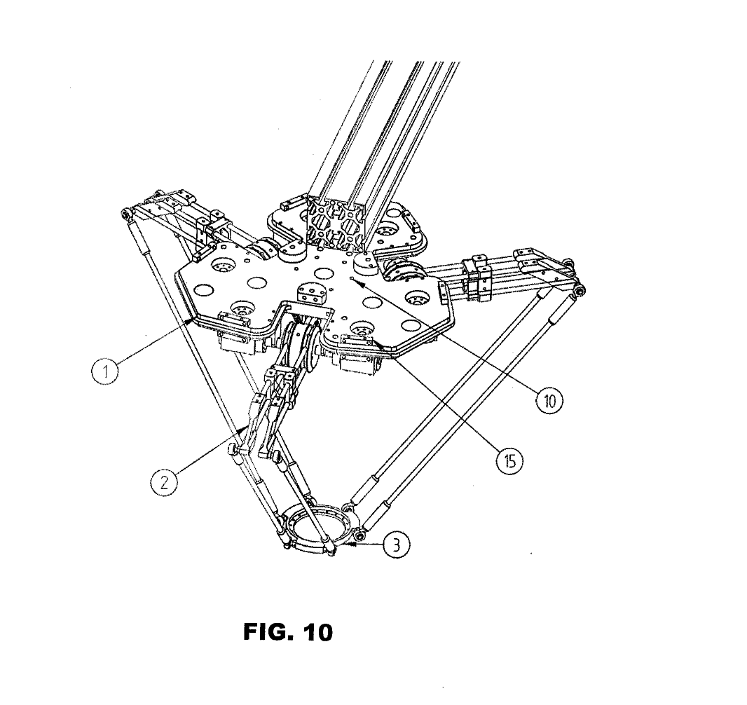

In FIG. 10 the attachment of the industrial delta type robot of the present invention to a transverse support beam is shown. The support beam incorporates a plurality of longitudinal grooves that contain screws or pins that also incorporate to the base plate (1). As shown in FIG. 10, the universal support beam holds a horizontal position. One portion of the bar is introduced over the central base section (10); the corresponding top protective cover (12) includes an opening through which the transverse support beam extends outward.

### Joints

According to the present invention, the joints consist of spherical bearings. The spherical joints consist of a sphere and a ring that surrounds the sphere, wherein two opposite ends of the sphere remain exposed; both the sphere and the ring forming the joint include a threaded rod or bolt to be attached to a respective coupling. It is difficult to separate these joints because the ring imprisons the sphere at all times. Besides, this type of joint has a greater mobility with respect to ball joints used in devices in prior art, for example, the one illustrated in the international patent application WO-00/32363. However, as will be apparent to a person skilled in the technical field, joints well known in the art such as ball joints may be used.

### Universal Effector

The system is completed with a ring shaped universal effector (3) that contains on its outer circumference six effector spherical joints (51), that assemble with the six aforementioned distal arm couplings, arranged along the perimeter of the part, and is represented in the figures with a circular form with a 120° angular offset between each pair of opposite joints; and an inner ring with two to thirty perforations of one or many diameters for the attachment of electrically or pneumatically driven interchangeable devices, wherein said preferred devices of the set may consist of scissor type grippers, double grippers, servomotors or double suction cups, selected from the range of the set. The effector of the present invention differs significantly from effectors in prior art. The universal effector (3) of the present invention is shown in FIG. 8. The effector consists of a ring (50) that includes three protrusions (53) for the connection of the respective three pairs of distal arms (45) through a cylindrical element of the spherical joint to attach each arm. According to the illustration in FIG. 8 and FIGS. 9 and 14, two cylindrical elements of the spherical joint are attached to a protrusion (53) of the ring (50) through a screwed joint.

Besides, the ring (50) of the universal effector (3) of the present invention includes a tool flange seat (55) that incorporates a plurality of perforations (52) to insert screws or bolts so a tool can be attached. In practice, the tool includes a flange that is placed on the seat (55) and attached to the ring (50) through screws and nuts that are inserted in the holes (52) of the ring and the tool flange holes, which are made to match so this can be accomplished. The circular form and the perforations of the effector make it different to effectors in prior art because this form and this perforations make the effector of the present invention more versatile for easily coupling any tool.

### Tools

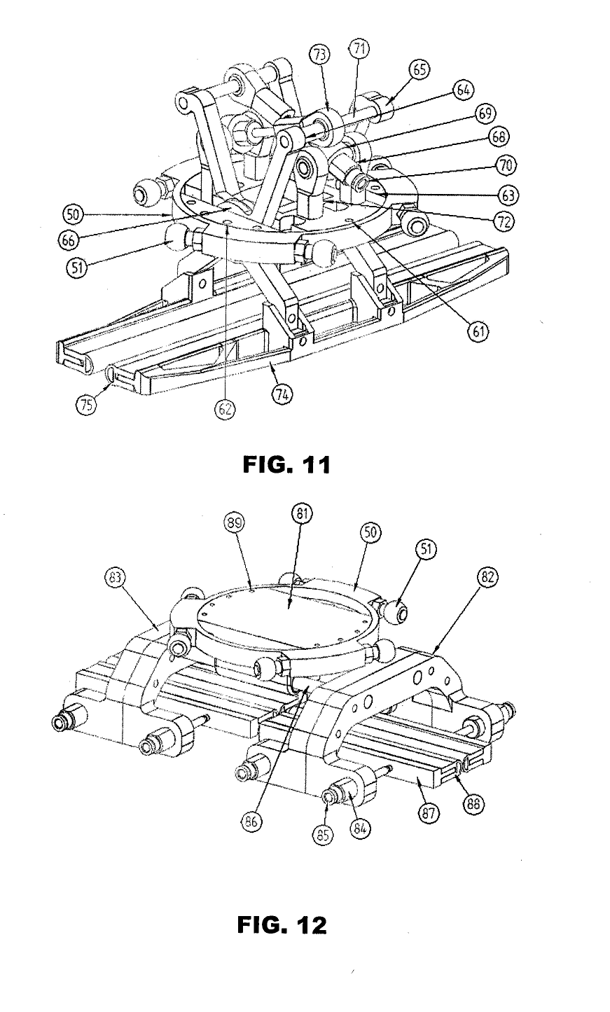

As an example, FIGS. 11 to 14 show various tools that can be attached to the effector of the present invention.

In FIG. 11 an isometric view of the industrial delta type robot effector of the present invention is shown with an interchangeable device of scissor type grippers, which consist of a first gripper (64), opposite to a second gripper (65), both assembled to a pair of shafts (71), which in turn are coupled to a top spherical joint (73) connected to the brace (69) of a piston (68) that has a pneumatic connection (70). The tool, on its lower portion, has a pair of rubber holders (74) that includes a retention rubber (75). Each of the rubber holders is attached to the grippers (64) and (65). This set is completed with another set of mirrored parts, creating the scissor, so that the device, while in use, makes the grippers, and thus the retention rubbers, (75) open or close by means of the air provided to the pneumatic connection (70). With this motion it is possible to hold and transport objects.

As shown in FIG. 11, the tool includes the coupling flanges, two lateral (63) and one central (61), that attach to the ring (50) of the universal effector (3), through bolts and screws that are inserted in the holes (62) of the tool flanges and the holes (52) of the ring (50) of the effector (3).

FIG. 12 illustrates an isometric view of the industrial delta type robot effector with a double pneumatic gripper interchangeable device, which shows on its upper portion a coupling flange (81) seated on the ring (50) of the universal effector (3), and on its lower portion a first (82) and second (83) set of grippers that are attached by means of gripper set (86) connecting rods and which in turn attached to rubber holding tracks (87) and rubbers (88) that open and close by means of pneumatic connections (85) of pneumatic pistons (84).

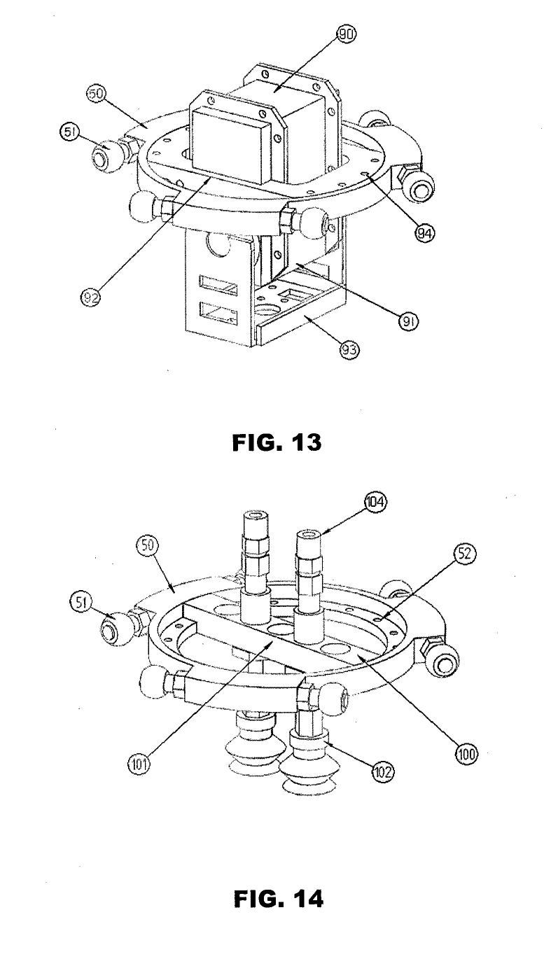

FIG. 13 illustrates an isometric view of the industrial delta type robot effector of the present invention with a tool (90) that incorporates a servomotor. The tool (90) includes a flange (92) that includes holes (94). The flange (92) has a tool servomotor (91) coupled to it and a multifunctional rotor (93) for various purposes. The flange (92) is attached to the ring (50) using bolts or screws that are placed inside the holes (52) and (94) of the ring (50) of the effector and the tool (90).

FIG. 14 shows an isometric view of the industrial delta type robot effector with a double suction cup (100) interchangeable device or tool. The tool includes a device flange or coupling (101) that includes perforations (105) (not illustrated). The flange also includes a set of bellows suction cups (102) that produce suction through a pneumatic connection (104).

### Covers

The base (1) also includes covers on both faces, bottom and top, of the base. These consist of a central top cover (12), two secondary top covers (13), and three bottom covers (14) for the central section of the base (10) and each secondary section (1) that are attached to form a single part. The top cover (12) includes an opening through which the transversal support bar extends outwards and the top covers (13) define a cavity to contain tools, accessories, and devices belonging to the robot, making effective use of spaces and avoiding the use of additional containers where accessories might get damaged or lost, while, in a preferred embodiment of the invention, the bottom covers (14) define a housing that contains the servomotors (20) and the shoulder rotor shafts (23); their lifetime and time until maintenance is extended with the covers. Also, the covers prevent any residue or motor grease from being in contact with the packaged material, which may be food or drugs. The covers, as a whole, provide an aesthetic appearance to the industrial robot of the present invention.

The industrial delta type robot comprises the following parts:
1. base,
2. articulate system of double multidirectional arms,
3. universal effector,
4. torque compensation device,
10. base central section,
11. secondary base sections,
12. top central protective cover,
13. top secondary protective cover,
14. bottom secondary protective cover,
15. cover fastener set,
16. cover fastening screw,
20. servomotor,
21. servomotor support,
22. shoulder rotor pulley,
23. shoulder rotor shaft,
24. shoulder rotor shaft cover,
25. shoulder rotor perforation set,
26. bearing,
27. support,
30. central support,
31. helical spring for rotor,
32. helical spring anchor 1,
33. helical spring anchor 2,
34. stabilizing support,
35. top stabilizing bar,
36. bottom stabilizing bar,
37 support 30 flat face,
38 central support 30 flange,
40. articulate arm,
40A. First arm,
40B. Second arm,
41. proximal arm,
41A. top proximal arm bar,
41 B bottom proximal arm bar,
42. arm separator,
43. elbow connector,
44. arm spherical joint,
45. distal arm,
46. distal arm coupling 1,
47. distal arm coupling 2,
48. proximal arm joint,
50. ring of the effector,
51. effector spherical joint,
52. set of perforations for interchangeable device coupling,
53. protrusion,
54. joint hole,
55. tool flange seat,
60. a scissor gripper type interchangeable device,
61. central tool coupling flange,
62. tool flange hole,
63. lateral tool coupling flange,
64. gripper 1,
65. gripper 2, 66. gripper arm attachment shaft,
67. gripper arm bearing,
68. pneumatic piston,
69. pneumatic piston brace,
70. piston pneumatic connection,
71. gripper support shaft,
72. bottom spherical joint,
73. top spherical joint,
74. rubber holder,
75. retention rubber,
80. double pneumatic grippers interchangeable device,
81. coupling flange,
82. first set of grippers,
83. second set of grippers,
84. pneumatic piston,
85. pneumatic piston connection,
86. gripper set connection bar,
87. rubber holder,
88. retention rubber,
89. tool flange holes,
90. servomotor device,
91. tool servomotor,
92. device flange,
93. multifunctional rotor,
94. tool flange holes,
100. suction cups interchangeable device,
101. device coupling,
102. set of bellows suction cups,
104. pneumatic connection, and
105. tool flange holes.

Therefore, the present invention is much less complex to assemble and more economic with respect to the recognized robots by the prior art. The robot only uses one base and top and bottom molded covers for each body, resulting in a base integrated to a single piece that can be easily and quickly manufactured besides being economic, lightweight, practical and resistant, making it affordable for both moderate and high levels of production.

Besides, the description includes any combination or sub combination of the elements of different types and/or modes in this description. Someone skilled in the technical field will recognize these characteristics and, therefore, the scope of this disclosure should be interpreted in light of the following claims and any equivalents thereof.

1. A delta type robot comprising a base (1) which supports three articulate arms (40) having a first arm (40A) and a second arm (40B), attached to an effector (3), wherein each of said first and second arms comprise
a proximal arm (41), attached on one end to a joint (44), and
a distal arm (45), attached on one end to the joint (44) and on the opposite end to a universal effector (3) through an effector joint (51), characterized in that each of the first and second proximal arms (41) is joined to a shoulder rotor pulley (22) in the end opposite to the joint (44), said shoulder rotor pulley (22) in turn coupled to a shaft (23) of a servomotor (20), the shoulder rotor pulley of the first and second proximal arms being placed in a frontal relationship and the ends of the shaft being joint to a respective bearing (26), both bearing joint to a support (27) which is firmly joint to a central support (30) placed on the base (1) for stabilizing and align the rotation axis of the shoulder rotor pulley (22) of the first and second arms of each articulate arm (40).

2. The delta type robot of claim 1, wherein the proximal arm (41) comprises a top proximal arm bar (41A) and a bottom proximal arm bar (41B).

3. The delta type robot of claim 1, wherein a shoulder rotor pulley (22) radially attached to respective first and second proximal arms (41) receives an angular motion of between 90 and −90° exerted by the servomotor.

4. The delta type robot of claim 1, wherein the shoulder rotor pulley (22) is attached to a spring (31) placed over the central support (30).

5. The delta type robot of claim 1, wherein the shoulder rotor pulley (22) of the first proximal arm (41) is attached so it can rotate on the bearing inserted on a first flat face of the support (27).

6. The delta type robot of claim 1, wherein the shoulder rotor pulley (22) of the second proximal arm (41) is attached so it can rotate on the bearing inserted on a second flat face of the support (27).

7. The delta type robot of claim 1, wherein the support (27) includes a cylindrical face that is firmly attached to the central support (30).

8. The delta type robot of claim 1, wherein each of the first and second proximal arms (41) include an arm joint (48) to join said first arm to the second proximal arm (41), and the first servomotor driving the first proximal arm (41) is configured as leader and the second servomotor driving the second proximal arm is configured as a slave.

9. A universal effector (3) for a delta type robot that comprises three pairs (2) is of articulate double arms (40) attached to an effector (3), wherein the effector (3) consists of a ring (50) that includes a tool flange seat (53) that incorporates a plurality of perforations (52) to insert screws or bolts so a tool can be attached.

10. The universal effector for a delta type robot in accordance with claim 9, wherein the effector includes three protrusions (53) for the connection of three distal double arm (45).

11. The universal effector for a delta type robot in accordance with claim 9, wherein the effector (3) couples a scissor type gripper.

12. The universal effector for a delta type robot in accordance with claim 9, wherein the effector (3) couples a double pneumatic gripper.

13. the universal effector for a delta type robot in accordance with claim 9, wherein the effector (3) couples a servomotor.

14. The universal effector of the delta type robot in accordance with claim 9, wherein the effector (3) couples double suction cups.
